(19) United States
(12) Patent Application Publication
(10) Pub. No.: US 2012/0303788 A1
(43) Pub. Date: Nov. 29, 2012

(54) Method for Associating Time Slots with Links Between Network Nodes of a Wireless Interconnected Network

(75) Inventors: Andreas Heinrich, Muenchen (DE); Matthias Scheffel, Unterhaching (DE)

(73) Assignee: Siemens Atiegesellschaft, Muenchen (DE)

(21) Appl. No.: 13/574,589

(22) PCT Filed: Jan. 19, 2011
(86) PCT No.: PCT/EP2011/050645

§ 371 Date: Jul. 20, 2012

(30) Foreign Application Priority Data
Jan. 22, 2010 (EP) 10000623.8

(51) Int. Cl. G06F 15/173

(52) U.S. Cl. 709/223

(57) ABSTRACT

A method for associating time slots with links between network nodes of a wireless interconnected network of a plurality of network nodes in which data are transmitted in the network on a time slot basis by association of the time slots to be used with the links on a plurality of channels, wherein a plurality of traffic requests each specifying a data transfer between a source node and a destination node are prescribed and set one or more time slot sequences that each describe a time-based sequence of time slots associated with links between adjacent network nodes of a transmission path between the source and destination nodes, and an association methodology for data transmission via a plurality of channels is determined, considering all predefined traffic requests, based on an optimization criterion, and configured such that the number of time slots used in the association methodology is as low as possible.

### CROSS-REFERENCE TO RELATED APPLICATIONS

This is a U.S. national stage of international application No. PCT/EP2011/050645 filed 19 Jan. 2011. Priority is claimed on European Application No. 10000623.8 filed 22 Jan. 2010, the content of which is incorporated herein by reference in its entirety.

### BACKGROUND OF THE INVENTION

1. Field of the Invention

The invention relates to a method for assigning time slots to links between network nodes of a wireless meshed network and to a method for transferring data using the method for assigning time slots. The invention further relates to a network management unit and to a wireless meshed network.

2. Description of the Related Art

Wireless meshed networks, which are frequently also called mesh networks, are based on the principle that data is transferred via a plurality of network nodes communicating with one another by wireless communication functionality from one network node to another using hops, i.e., redirects via other nodes. The networks are structured such that, within range of a network node, a plurality of other network nodes to which data can be sent are located. In the transfer of data in meshed networks, scheduling methods are used, by which time slots, in which the link can be used for transferring data, can be assigned to corresponding links between two network nodes. Data transfer usually occurs via a plurality of radio channels that can be used in parallel for data transmission.

In wireless meshed networks, a plurality of traffic requests have as a rule to be fulfilled simultaneously, each traffic request specifying a data transfer between a source node and a destination node in the network. Here, care must be taken to ensure that collisions are avoided such that a time slot for a data transfer on a defined channel is assigned to a plurality of links. While known scheduling methods do ensure that data transfer is free of collisions, they view the individual traffic requests separately from one another, which can lead to a large overall delay in the data transfers according to all of the traffic requests.

### SUMMARY OF THE INVENTION

It is therefore an object of the invention to optimize the assignment of time slots to links between network nodes of a wireless meshed network to achieve a smallest possible delay for a plurality of traffic requests.

This and other objects and advantages are achieved in accordance with the invention by a method in which time slots are assigned to links between network nodes of a wireless meshed network of a plurality of wirelessly communicating network nodes, where data and in particular data packets are transferred in the network on a time slot basis by the assignment of time slots to be used for data transfer to the links on a plurality of radio channels. A plurality of traffic requests are predefined, where each traffic request specifies a data transfer between a source node and a destination node and setting one or more time slot sequences. Each time slot sequence describes a temporal sequence of assignment of time slots to links between adjacent network nodes of a transmission path between the corresponding source node and the corresponding destination node. That is, the sequence sets the temporal sequence in which time slots are assigned to the links, without defining precisely which time slot is used for the data transfer via a link.

In accordance with the method of the invention, an assignment scheme based on an optimization criterion is determined for the plurality of radio channels which can be used for data transfer, and taking into consideration all predefined traffic requests. The assignment scheme is specified by a selected time slot sequence for each traffic request and an assignment of time slots to links of the selected time slot sequences of all of the traffic requests. The assignment scheme is characterized in that in the assignment scheme the temporal sequence of assignment of all selected time slot sequences is retained and interleaving of the time slots is permitted such that a time slot assigned exclusively to one or more links of one or more second time slot sequences which differ from the first time slot sequence can be disposed between two time slots, each assigned to a link of a first selected time slot sequence. That is, a time slot that belongs only to one or more links of other time slot sequences can lie between two time slots that are assigned exclusively or also among others to corresponding links of the same time slot sequence.

An essential aspect of the invention is, in addition to the interleaving of the time slots, the above-mentioned optimization criterion. This criterion is configured such that the number of time slots used in the assignment scheme is as low as possible. In this way, a compact assignment scheme can be provided simultaneously for a plurality of traffic requests. The assignment scheme in accordance with the invention can, taking the optimization criterion into account, be determined using conventional methods. In particular, the assignment scheme can be determined with the aid of a method for solving an integer or mixed integer linear optimization problem. Preferably, a conventional branch-and-bound method is used here. Optionally, there is also the possibility of determining the above assignment scheme in a suitable manner by an iterative method, in which the number of time slots to be used in the assignment scheme is gradually increased or decreased until an optimal solution with the lowest number of time slots is found.

In a further embodiment of the method in accordance with the invention, each time slot in the assignment scheme is assigned a metric parameter which is greater, the later the time slot occurs in the assignment scheme, the metric parameter of the time slot which occurs last in the assignment scheme being minimized, in accordance with the optimization criterion. Based upon this definition of the optimization criterion, the method in accordance with the invention the invention can be implemented easily and efficiently.

In a further particularly preferred embodiment, in the determination of the assignment scheme in accordance with the invention, the single-transmitter restriction is taken into account, according to which links assigned to the same time slot which are to be used for transferring data on different channels have to be disjoint, i.e., have to have both different start nodes and different destination nodes. In accordance with this restriction, each network node can, at any one time, send or receive data only on one channel. The restriction can be incorporated in a suitable manner by a correspondingly defined limiting condition in the determination of the assignment scheme based on the above optimization criterion.

In a further particularly preferred embodiment, all time slot sequences of a traffic request are set such that, in the transfer of data according to each time slot sequence, a minimum quality standard is observed with respect to the reliability of the data transfer. In this way, in addition to ensuring the smallest possible delay in the time slot assignment, a minimum reliability can also be ensured for the individual traffic requests. In a particularly preferred embodiment, the time slot sequences of a traffic request are set based on the method which is disclosed in German patent application number DE 2010P01063. This patent application claims the priority of European patent application number EP 10 000 623.8 filed on 22 Jan. 2010. The disclosure content of these two patent applications is incorporated by reference to the content of this application in their entity. Based on the method described there, it is achieved that the correspondingly determined assignment and/or time slot sequences fulfill a minimum quality standard and furthermore ensure energy-efficient operation of the network nodes when data is transferred.

In a further embodiment, the method in accordance with the invention is executed in a meshed network comprising a wireless sensor network, in which at least some of the network nodes are sensors, and in particular sensors with an autonomous energy supply. For such sensor networks, it is particularly important for the individual sensor network nodes to operate as energy-efficiently as possible, so the embodiment of the method in accordance with the invention described hereinabove is particularly suitable for use in such a network.

In addition to the method described hereinabove for assigning time slots to links between network nodes in a meshed network, the invention further comprises a method resulting therefrom for transferring data on a time slot basis in a wireless meshed network having a plurality of network nodes. A time slot scheme for a plurality of traffic requests is determined using the disclosed embodiments of the assignment method in accordance with the invention described hereinabove and, based on this assignment scheme, data is transferred between the source nodes and the destination nodes of all of the traffic requests on a plurality of channels. The disclosed embodiment of the method in accordance with the invention can be combined with data transfer methods known per se, such as the WirelessHART or conventional Institute of Electrical and Electronic Engineers (IEEE) 805.15.4 or Industry Standard Architecture (ISA) 100.11a standards. Only the assignment of the time slots to network nodes has to be implemented, e.g., in a network management unit.

The invention further relates to a network management unit for a wireless meshed network of a plurality of network nodes communicating wirelessly with one another, where the network management unit is configured to assign time slots to links between network nodes based on the disclosed embodiments of the assignment method in accordance with the invention described hereinabove.

It is also an object of the invention to provide a wireless meshed network of a plurality of network nodes communicating wirelessly with one another having such a network management unit. The network nodes and the network management unit are configured such that they can transfer data based on the disclosed embodiments of the transfer method described hereinabove.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Exemplary embodiments of the invention will be described in detail below with reference to the enclosed drawings, in which:

FIG. 1 shows a meshed wireless network, in which transmission paths for two traffic requests are selected based on an embodiment of the method in accordance with the invention;

FIG. 2 shows a diagram which shows an assignment methodology determined in accordance with the invention for the paths shown in FIG. 1;

FIG. 3 shows a wireless meshed network, in which transmission paths for the same traffic requests as in FIG. 1 are selected based on an alternative method which does not form part of the invention;

FIG. 4 shows a representation of the assignment scheme according to the alternative method for the paths shown in FIG. 3; and

FIG. 5 is a flowchart of the method in accordance with an embodiment of the invention.

### DETAILED DESCRIPTION OF THE PREFERRED EMBODIMENTS

Embodiments of the method in accordance with the invention are described below for a multi-hop meshed network, in which data packets are transmitted on a time slot basis using an appropriate standard such as, e.g., WirelessHART. The method in accordance with the invention describes a novel assignment of time slots to corresponding wireless links between network nodes and enables thereby a central assignment of time slots for a plurality of traffic requests in the form of corresponding data transfers between various source nodes and destination nodes. The method of the invention ensures a high degree of reliability of data transfer coupled with a simultaneously small delay time.

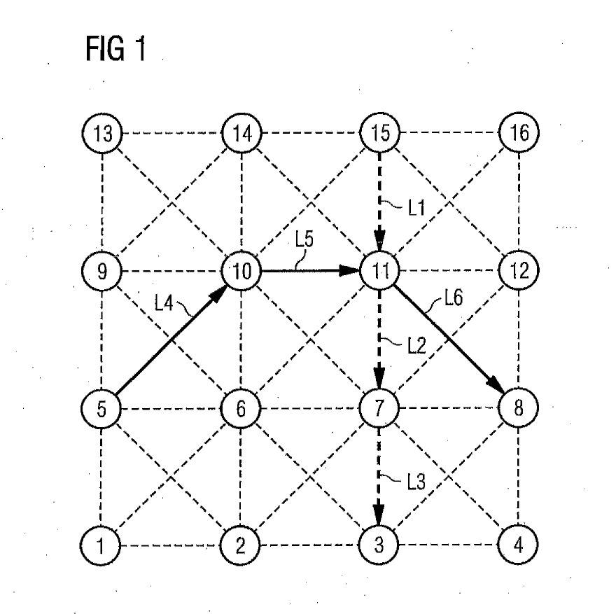

FIG. 1 shows an example of a wireless meshed network, in which the method in accordance with the invention can be implemented. Here, the network comprises a plurality of network nodes 1, 2, . . . , 16, which are arranged spatially in squares. The individual network nodes can communicate wirelessly with adjacent network nodes, which is indicated by corresponding dashed lines between the network nodes. Each direct connection between two network nodes as per the dashed lines represents a wireless link that can be used for the transfer of data in a corresponding time slot.

In the representation as per FIG. 1, a traffic request exists for the transfer of data between the network node 15 and the network node 3 and a traffic request for the transfer of data between the network node 5 and the network node 8. For each of these traffic requests, a plurality of selectable time slot sequences is set in the form of corresponding routes. A route thus describes a transmission path between source and destination nodes via adjacent links in the network and a corresponding assignment of time slots to be used for data transfer to the links. The transfer of data in the network occurs over a plurality of radio channels, where it is possible for all of the radio channels in a time slot optionally to be used for data transfer, provided it is ensured that within a time slot disjoint links with different start and destination nodes are used. This takes into account the fact that a network node can at any one time send and receive data on one channel only.

In the presently contemplated exemplary embodiment, for the traffic request between node 15 and node 3 all routes extending over three hops which have a reliability of 0.9 or higher have been set as a selectable route. The same applies to the traffic request between node 5 and node 8. The setting of the selectable routes for each traffic request can be done in various ways depending on the exemplary embodiment. In a preferred embodiment, the method described in the above-mentioned German patent application number DE 2010P01063 is used for determining time slot sequences and routes. All routes determined in such a way have a minimum quality standard, which depends on the reliability of the data transfer of the corresponding time slot assignment.

For reasons of clarity, not all selectable routes are reproduced in FIG. 1 for each of the traffic requests. Instead, only those routes are shown which are determined by the embodiments of the method in accordance with the invention and are contained in the assignment scheme which follows from the method in accordance with the invention. In FIG. 1, this is, for the traffic request between node 15 and node 3, the route that extends via the links L1, L2 and L3, the link L1 lying between nodes 15 and 11, the link L2 between nodes 11 and 7 and the link L3 between nodes 7 and 3. Correspondingly, for the traffic request between node 5 and node 8, a route emerges via the links L4, L5 and L6, the link L4 extending between the nodes 5 and 10, the link L5 between the nodes 10 and 11 and the link L6 between the nodes 11 and 8.

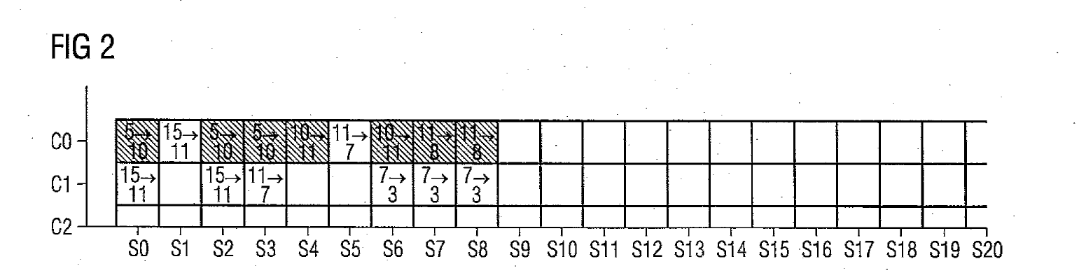

Before discussing the assignment scheme determined in accordance with the invention as shown in FIG. 2, it will firstly be explained in general terms how the corresponding assignment scheme is determined in the embodiment described here. Determination of the assignment scheme is based on formulating and solving a mixed integer optimization problem, the mathematical description of which will be explained hereinbelow.

To formulate the optimization problem mathematically, the variables defined hereinbelow must be taken into account:
N Set of network nodes in the wireless network,
ε Set of possible links in the network, i.e., edges between nodes which can communicate directly with one another,
D Set of traffic requests between source and destination nodes which are to be taken into account in the method,
R_{d} Set of selectable routes for a traffic request d, a route corresponding to a time slot sequence, according to which one or multiple corresponding time slots to be used for data transfer are assigned in a predefined temporal sequence to each of the links of a transmission path,
(e_{r,i})_{i∈{1, 2, 3, . . . , l}_{ᵣ}} a list of the links for constructing the route r, the list being based on a temporal sequence of lᵣ ∈ N links and multiple uses of links being modeled by the multiple mention of the link in the list,
S Number of time slots usable for the transfer of data,
c ∈ N={1, 2, 3, . . . } Number of radio channels simultaneously usable for the transfer of data,
mₛ ∈ N oder R⁺ a metric parameter of a time slot s, which increases strictly monotonically for temporally later time slots in the assignment scheme, it being possible, e.g., for the parameter to have the value 1 for the first time slot, the value 2 for the second time slot, etc.,
α_{e,n} ∈ {0, 1} a parameter that stipulates whether an edge e of a link starts in the node n (value 1) or not (value 0),
P_{d,r} ∈ {0, 1} a variable that determines whether a route r has been selected for transfer in accordance with a traffic request d (value 1) or not (value 0),
S_{d,r,l,s} ∈ {0, 1} a variable that determines whether the time slot s has been assigned to the i-th link of the route r selected for the traffic request d,
Uₛ ∈ {0, 1} a variable that determines whether a time slot s is used for a data transfer (value 1) or not (value 0),
M ∈ N oder R³⁰ a variable that determines the maximum metric parameter of all of the time slots used in the assignment scheme.

Based on the above definitions, the optimization criterion in accordance with the invention is formulated as follows:

Minimize M (1.1),

i.e., minimize the largest metric parameter of a time slot within the assignment scheme, which equates to making the number of time slots used in the assignment scheme as low as possible.

For the minimization problem (1.1), the following limiting conditions, which mathematically read as follows, must be taken into account:

$$\begin{matrix}\begin{matrix}{\sum }_{r ∈ {R}_{d}} {P}_{d , r} = 1 & ∀ d ∈ D ,\end{matrix} & ( 1.2 ) \\ \begin{matrix}{\sum }_{s ∈ S} {S}_{d , r , i , s} = {P}_{d , r} & \begin{matrix}\begin{matrix}∀ d ∈ D , \\ ∀ r ∈ {R}_{d} ,\end{matrix} \\ ∀ i ∈ \{ 1 , 2 , … , {l}_{r} \} ,\end{matrix}\end{matrix} & ( 1.3 ) \\ \begin{matrix}{\sum }_{{{s}_{1} ∈ S}_{{m}_{{s}_{1}} \leq {m}_{s}}} {S}_{d , r , i + 1 , {s}_{1}} + {\sum }_{{{s}_{2} ∈ S}_{{m}_{{s}_{2}} > {m}_{s}}} {S}_{d , r , i , {s}_{2}} \leq 1 & \begin{matrix}\begin{matrix}\begin{matrix}∀ s ∈ S , \\ ∀ d ∈ D ,\end{matrix} \\ ∀ r ∈ {R}_{d} ,\end{matrix} \\ ∀ i ∈ \{ 1 , 2 , … , {l}_{r} - 1 \} ,\end{matrix}\end{matrix} & ( 1.4 ) \\ \begin{matrix}{\sum }_{d ∈ D} {\sum }_{r ∈ {R}_{d}} {\sum }_{{i ∈ \{ 1 , 2 , … , {l}_{r} \} :}_{{α}_{{e}_{r , i} n} = 1}} {S}_{d , r , i , s} \leq 1 & \begin{matrix}∀ s ∈ S , \\ ∀ n ∈ N ,\end{matrix}\end{matrix} & ( 1.5 ) \\ \begin{matrix}{\sum }_{d ∈ D} {\sum }_{r ∈ {R}_{d}} {\sum }_{i ∈ \{ 1 , 2 , … , {l}_{r} \}} {S}_{d , r , i , s} \leq c \cdot {U}_{s} & ∀ s ∈ S ,\end{matrix} & ( 1.6 ) \\ \begin{matrix}M \geq s \cdot {U}_{s} & ∀ s ∈ S .\end{matrix} & ( 1.7 )\end{matrix}$$

As already mentioned above, an assignment scheme is determined by the minimization aim as per (1.1) which uses as few time slots as possible. The limiting condition (1.2) ensures that for all traffic requests only one route is ever used. The above equation (1.3) guarantees that for each link of the route selected for the traffic request, a time slot for the transfer of data is provided. If the route has not been selected, no time slot is required.

The correct sequence of time slots such that for each route the assignment scheme maintains the temporal sequence of the assignment of time slots to links of the route is taken into account by the condition (1.4). For each time slot and each link of a route, the subsequent link of the route must be prevented from being assigned an earlier or the same time slot as the link under consideration.

The above condition (1.5) represents the previously mentioned criterion of disjoint links in the same time slot, i.e., that a network node in an allocated time slot is assigned only to one data transfer. The above condition (1.6) sets the number of channels that are simultaneously usable in one time slot. At the same time, these equations determine whether a time slot is used. Finally, the time slot with the largest metric is detected via the equation (1.7).

The optimization problem described above can be solved in a manner known per se using conventional methods from. This optimization problem is a mixed integer linear optimization problem, which in a preferred embodiment is solved by the known branch-and-bound method. As the methods of solving the optimization problem are known per se, no detailed description of the methods will be given.

A key aspect of formulating the above optimization problem is that the limiting conditions be chosen such that interleaving of the time slots in the assignment scheme to be determined be permitted. That is, on the routes set for each of the traffic requests, the corresponding data does not have to be transferred in one piece in directly consecutive time slots, but time slots of other routes may lie between the time slots of one route, it being ensured, however, that the temporal sequence of the assignment of time slots set via each route be adhered to. In this way, a very compact structure of the time slot scheme is achieved with a low number of time slots needed.

The disclosed embodiments of the method in accordance with the invention enables the use of routes of any types. In particular, the routes may include redundant transfers on one or all links or else repeatedly the same links between two network nodes of a traffic request. In this way, for example, routes can be predefined for the traffic requests that fulfill a minimum degree of reliability and/or that are particularly efficient in terms of the energy consumption of the nodes during a data transfer.

In the preceding, the optimization criterion, according to which an assignment scheme should contain as low as possible a number of time slots, was solved based on an optimization problem formulated by corresponding metrics of the time slots. There is, however, optionally also the possibility of solving a time slot assignment as per the optimization criterion iteratively by increasing and/or decreasing the number of time slots in the total set S of time slots S. This can be done by starting with a large/small value of the number of time slots until no solution or an implementable solution is found. Where the number of time slots is decreased, the last implementable time slot assignment is the optimal solution, whereas where the number of time slots is increased, the first possible solution represents the optimal result. This strategy may possibly save computing time in determining the assignment scheme.

FIG. 2 shows a diagram which reproduces an assignment scheme determined according to the invention for the traffic requests from FIG. 1. In the scheme, for the traffic request to transfer data from network node 15 to network node 3, the route via the links L1, L2 and L3 was selected. According to this route, three time slots are assigned to the link L1, two time slots to the link L2 and three time slots to the link L3. For the traffic request for a data transfer from node 5 to node 8, the route via the links L4, L5 and L6 was selected. Here, three time slots were assigned to the link L4, two time slots to the link L5 and two time slots also to the link L6. In FIG. 2, time slots are labeled S0, S1, . . . , S20, whereas the three channels usable for data transfer are labeled C0, C1 and C2. The assignment of a time slot to corresponding links is represented by boxes above the time slot, where each box stands for a link that is indicated by its start point and its destination point with an arrow lying therebetween. Links for the traffic request from node 5 to node 8 are indicated by hatched boxes, whereas links for the traffic request from node 15 to node 3 are represented by white boxes.

As can be seen from the assignment scheme shown in FIG. 2, a total of nine time slots are needed to fulfill all of the traffic requests. In particular, it can be seen that the various routes of the traffic requests may be interleaved. For example, between the time slots S0 and S2, in which data is transferred on the channel C0 via the link L4 on the route from node 5 to node 8, the time slot S1 is disposed for the link L1 of the other route from node 15 to node 3.

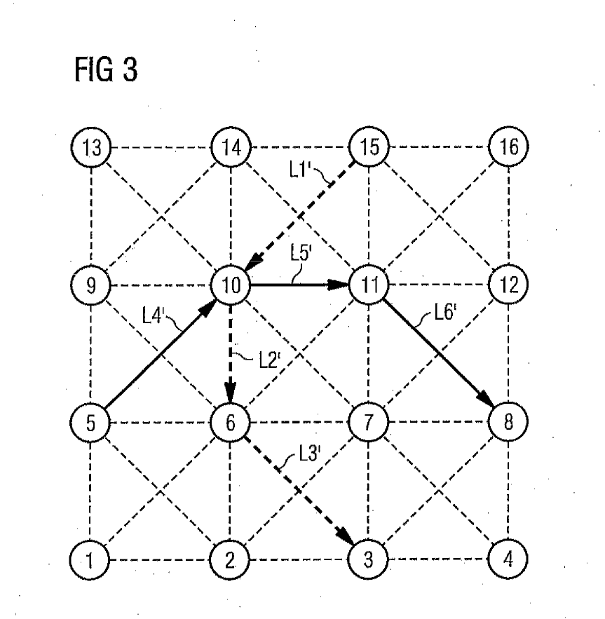

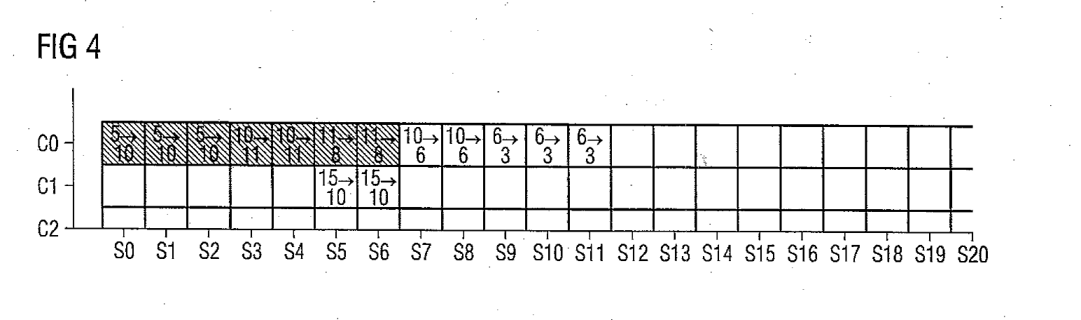

The assignment methodology in accordance with the invention as shown in FIG. 1 and FIG. 2 was compared with the assignment scheme shown in FIG. 3 and FIG. 4. In contrast to the assignment methodology in accordance with the invention, for the methodology depicted in FIG. 3 and FIG. 4 an heuristic approach was chosen for determining routes for the traffic requests between nodes 5 and 8 and between nodes 15 and 3. Of the routes for each traffic request, the route with the lowest number of repetitions was used, and both routes were assigned time slots in as compact a manner as possible, without the possibility of the interleaving of time slots being considered.

As appreciable from FIG. 3, for the heuristic approach, the links L1′, L2′ and L3′ were used for the traffic request between node 15 and node 3. In contrast, for the traffic request between node 5 and node 8 the links L4′, L5′ and L6′ were used. The assignment scheme that emerges for these routes is shown in FIG. 4, which reproduces a diagram analogous to FIG. 2. The route between node 5 and node 8 is again indicated by hatched boxes, whereas the route between node 15 and node 3 is represented by white boxes. As can be seen from FIG. 4, twelve (12) time slots are now needed to fulfill all of the traffic requests instead of nine (9) time slots as per the assignment scheme shown in FIG. 2. The delay in the transfer of data for all of the traffic requests is thus greater, although for the route from node 15 to node 3 a transfer via fewer time slots was chosen than in the assignment scheme shown in FIG. 2.

As is apparent from the above remarks, the invention has a range of advantages. In particular, an optimal assignment scheme is found simultaneously for a plurality of traffic requests such that the number of time slots used for data transfer is minimized. In this way, the communication delay with respect to all of the traffic requests is kept as low as possible. Through appropriate setting of usable time slot sequences for each of the traffic requests, requirements in terms of the minimum reliability of data transfer can also be fulfilled. In addition, the complexity of the method can be adapted by reducing the number of usable time slot sequences for each traffic request. As is evident from comparison of the assignment scheme in accordance with the invention as per FIG. 1 and FIG. 2 with a heuristic approach as per FIG. 3 and FIG. 4, the disclosed embodiments of the method of he invention leads in fact to a compact assignment scheme with a lowest possible number of time slots to be used.

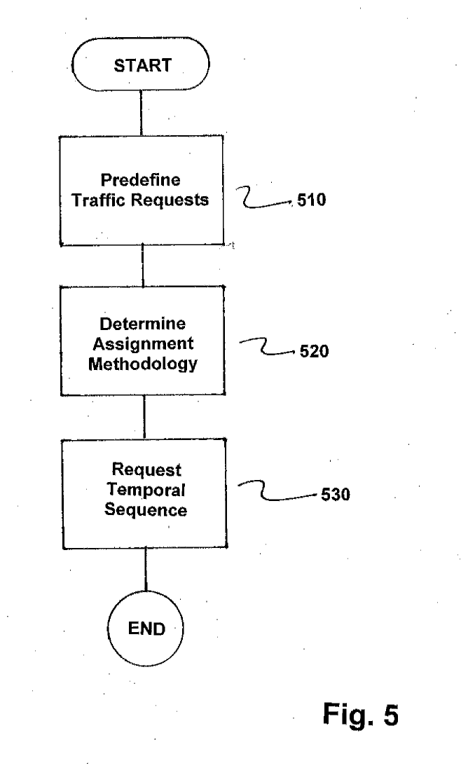

FIG. 5 depicts a method for assigning time slots to links between network nodes of a wireless meshed network of a plurality of wirelessly communicating network nodes, where data is transferred in the wireless meshed network of the plurality of wirelessly communicating network nodes on a time slot basis by assignment of the time slots to be used for data transfer to links on a plurality of channels.

The method comprises predefining a plurality of traffic requests, as indicated in step 510. In accordance with the method of the invention, each predefined traffic request of the plurality of traffic requests specifies a data transfer between a source node and a destination node of the network nodes, and sets at least one time slot sequence describing a temporal sequence of assigned time slots to links between adjacent ones of the network nodes of a transmission path between the source node and the destination node.

An assignment methodology for the plurality of channels, taking into account all of the predefined traffic requests, based on an optimization criterion is determined, as indicated in step 520. In accordance with the method of the invention, the assignment methodology is specified by a selected time slot sequence for each traffic request of the plurality of traffic requests and an assignment of the time slots to links of selected time slot sequences of all of the plurality of traffic requests.

A temporal sequence of assignments of all selected time slot sequences in the assignment methodology is requested, and the time slots are interleave such that a time slot of the time slots assigned exclusively to at least one link of at least one second time slot sequence that differs from a first time slot sequence is disposable between two time slots, each of the two time slots being assigned to a link of a first selected time slot sequence, as indicated in step 530. In accordance with the method of the invention, the optimization criterion is configured to minimize the number of time slots used in the assignment methodology.

While there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-12. (canceled)

13. A method for assigning time slots to links between network nodes of a wireless meshed network of a plurality of wirelessly communicating network nodes, data being transferred in the wireless meshed network of the plurality of wirelessly communicating network nodes on a time slot basis by assignment of the time slots to be used for data transfer to links on a plurality of channels, comprising:
predefining a plurality of traffic requests, each predefined traffic request of the plurality of traffic requests specifying a data transfer between a source node and a destination node of the network nodes, and setting at least one time slot sequence describing a temporal sequence of assigned time slots to links between adjacent ones of the network nodes of a transmission path between the source node and the destination node;
determining an assignment methodology for the plurality of channels and taking into account all of the predefined traffic requests based on an optimization criterion, the assignment methodology being specified by a selected time slot sequence for each traffic request of the plurality of traffic requests and an assignment of the time slots to links of selected time slot sequences of all of the plurality of traffic requests; and
retaining a temporal sequence of assignments of all selected time slot sequences in the assignment methodology and interleaving the time slots such that a time slot of the time slots assigned exclusively to at least one link of at least one second time slot sequence which differs from a first time slot sequence is disposable between two time slots, each of the two time slots being assigned to a link of a first selected time slot sequence;
wherein the optimization criterion is configured to minimize a number of time slots used in the assignment methodology.

14. The method as claimed in claim 13, wherein each time slot in the assignment methodology is assigned a metric parameter which is greater, the later the time slot occurs in the assignment scheme, and wherein the metric parameter of the time slot which occurs last in the assignment methodology is minimized in accordance with the optimization criterion.

15. The method as claimed in claim 13, wherein the assignment methodology is determined based on a method for solving an integer linear optimization problem.

16. The method as claimed in claim 14, wherein the assignment methodology is determined based on a method for solving an integer linear optimization problem.

17. The method as claimed in claim 15, wherein the assignment methodology is determined based on a branch-and-bound method.

18. The method as claimed in claim 13, wherein the assignment methodology is determined taking into account that the links assigned to the same time slot which are to be used for data transfer on various channels of the plurality of channels must be disjoint.

19. The method as claimed in claim 13, wherein at least one time slot sequence of a traffic request is configurable such that the time slots within the time slot sequence are assigned to a link more than once.

20. The method as claimed in claim 13, wherein all time slot sequences of a traffic request are set such that, during data transfer in accordance with each time slot sequence, a minimum quality standard is maintained with respect to reliability of the data transfer.

21. The method as claimed in claim 13, wherein the meshed network comprises a wireless sensor network of the plurality of wirelessly communicating network nodes, and wherein at least some of the plurality of wirelessly communicating network nodes are sensors.

22. The method of claim 21, wherein the sensors have an autonomous energy supply.

23. A method for transferring data on a time slot basis in the wireless meshed network comprising a plurality of network nodes, wherein a time slot methodology for the plurality of traffic requests is determined by the method as claimed in claim 1; and wherein the data transfer is based on the determined time slot methodology of all traffic requests on the plurality of channels between source nodes and destination nodes of the plurality of network nodes.

24. The method as claimed in claim 23, wherein the method is based on data transfer in accordance with one of WirelessHART standard, an Institute of Electrical Electronics Engineers (IEEE) 802.15.4 standard and an Industry Standard Architecture (ISA) 100.11a standard.

25. A network management unit for a wireless meshed network of a plurality of network nodes communicating wirelessly with one another, the network management unit being configured to assign time slots to links between network nodes by:
predefining a plurality of traffic requests, each predefined traffic request of the plurality of traffic requests specifying a data transfer between a source node and a destination node of the network nodes, and setting at least one time slot sequence describing a temporal sequence of assigned time slots to links between adjacent ones of the network nodes of a transmission path between the source node and the destination node;
determining an assignment methodology for the plurality of channels and taking into account all of the predefined traffic requests based on an optimization criterion, the assignment methodology being specified by a selected time slot sequence for each traffic request of the plurality of traffic requests and an assignment of the time slots to links of selected time slot sequences of all of the plurality of traffic requests; and
retaining a temporal sequence of assignments of all selected time slot sequences in the assignment scheme and interleaving the time slots such that a time slot of the time slots assigned exclusively to at least one link of at least one second time slot sequence which differs from a first time slot sequence is disposable between two time slots, each of the two time slots being assigned to a link of a first selected time slot sequence;
wherein the optimization criterion is configured to minimize a number of time slots used in the assignment methodology.

27. A wireless meshed network of a plurality of network nodes communicating wirelessly with one another, comprising a network management unit configured to assign time slots to links between the plurality of network nodes by:
predefining a plurality of traffic requests, each predefined traffic request of the plurality of traffic requests specifying a data transfer between a source node and a destination node of the network nodes, and setting at least one time slot sequence describing a temporal sequence of assigned time slots to links between adjacent ones of the network nodes of a transmission path between the source node and the destination node;
determining an assignment methodology for the plurality of channels and taking into account all of the predefined traffic requests based on an optimization criterion, the assignment methodology being specified by a selected time slot sequence for each traffic request of the plurality of traffic requests and an assignment of the time slots to links of selected time slot sequences of all of the plurality of traffic requests; and
retaining a temporal sequence of assignments of all selected time slot sequences in the assignment scheme and interleaving the time slots such that a time slot of the time slots assigned exclusively to at least one link of at least one second time slot sequence which differs from a first time slot sequence is disposable between two time slots, each of the two time slots being assigned to a link of a first selected time slot sequence;
wherein the plurality of network nodes and the network management unit are configured to transfer data by:
determining a time slot methodology for the plurality of traffic requests; and
transferring data based on the determined time slot methodology between the source nodes and the destination nodes of all the plurality of traffic requests on a plurality of channels; and
wherein the optimization criterion is configured to minimize a number of time slots used in the assignment methodology.
